(19) United States
(12) Patent Application Publication
(10) Pub. No.: US 2003/0231488 A1
(43) Pub. Date: Dec. 18, 2003

(54) Fragrance emitting lamp shade and lamp employing the same

(76) Inventor: Eric Albee, Columbus, NJ (US)

Correspondence Address: Allen R. Kipnes, Esq., WATOV & KIPNES, P.C., P.O. Box 247, Princeton Junction, NJ, 08550, US

(21) Appl. No.: 10/456,051

(22) Filed: Jun. 6, 2003

Related U.S. Application Data
(60) Provisional application No. 60/388,630, filed on Jun. 14, 2002.

(51) Int. Cl. F21V 33/00

(52) U.S. Cl. 362/96; 362/253; 362/351

(57) ABSTRACT

A lamp used in conjunction with a light emitting fixture in which a lamp shade has incorporated therein a fragrance which is emitted, especially when heated from heat emanating from the light source.

### FIELD OF THE INVENTION

The present invention is generally directed to a fragrance emitting lamp which includes a light fixture and a lamp shade in which the lamp shade is made from a fragrance emitting material or a material that has fragrance applied thereto.

### SUMMARY OF THE INVENTION

The present invention is generally directed to a fragrance emitting lamp including a light fixture and a lamp shade in which the lamp shade inherently contains or has incorporated therein a fragrance emitting material capable of emitting a pleasant aroma especially when in the presence of heat provided by the light emitting portion of the light fixture.

In a particular aspect of the present invention, there is provided a lamp comprising:

a) a base;

b) a light emitting fixture operatively connected to the base; and

c) a lamp shade secured over the light emitting fixture and comprised of a fragrance emitting material.

### BRIEF DESCRIPTION OF THE DRAWINGS

The following drawing is illustrative of the embodiment of the invention and is not intended to limit the invention as encompassed by the application.

FIG. 1 is a is a perspective view of a lamp employing a fragrance emitting lamp shade in accordance with the present invention.

### DETAILED DESCRIPTION OF THE INVENTION

The present invention is generally directed to a lamp including a lamp shade made of a fragrance emitting material or having a fragrance emitting material incorporated therein. The lamp shade is fit over or associated with a light fixture.

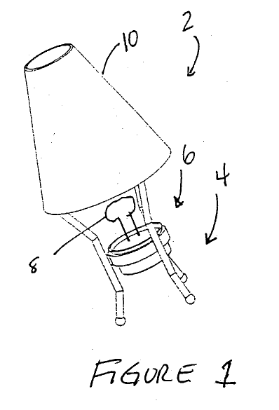

Referring to FIG. 1, there is shown a lamp including a light fixture employing the fragrance emitting lamp shade in accordance with the present invention. The lamp 2 has a base 4 which supports the light fixture including a source of light 6 which may be a light bulb 8 as specifically shown or a candle or other source of light. In a preferred form of the invention, the source of light provides sufficient heat to enhance release of the fragrance from the lamp shade as described hereinafter.

As shown in FIG. 1, the lamp shade (identified by the numeral 10) is secured to the base 4 so that it is positioned in proximity to the light source 6.

In accordance with the present invention, the lamp shade inherently releases a fragrance or is provided with a fragrance emitting material as hereinafter described.

The light fixture 6 including the base 4 can be made from any material including metal, plastic, glass, ceramic and the like. As previously indicated, the light fixture 6 can include an electric bulb, a candle or any other light source which preferably releases an amount of heat suitable for enhancing release of the fragrance emitting material from the lamp shade.

The lamp shade 10 may be made from a variety of materials any of which are able to carry a fragrance or have a fragrance applied to it by diffusion or other means. In a particular aspect of the present invention, the lamp shade may be made from a plastic material which is injection molded into the form of a lamp shade.

It will be understood that the lamp shades can be formed by thermoforming, injection molding, casting, blow molding, hand forming, compression molding, die cutting and the combination of panel sections and the like. Injection molding is a preferred form of making a lamp shade of the present invention.

The lamp shade made from a variety of materials including, but not limited to, polyethylene, polypropylene, ethyl vinyl acetate, K-resin, styrene polymers and copolymers, rubbers, polyvinyl chloride, ethyl methacrylate polymers, ABS, polyamide, acrylics, acrylic emulsions, latex, combinations thereof and the like.

Fragrances while are available for use in the present invention are any fragrance that may be applied to or incorporated into a lamp shade material and which may be released over time in response to the absence or the presence of heat provided by a typical light source such as a light bulb or candle. Fragrances of this type are readily available from fragrance suppliers such as International Flavors and Fragrances, Givaudan and the like.

The lamp shade o the present invention is preferably produced by an injection molding process in which the plastic material forming the lamp shade is combined in a molten condition with a suitable fragrance or fragrance concentrate and then the lamp shad is molded into a desirable form. Injection molding techniques are well known in the art.

The selection of a suitable fragrance will depend in part on the rate it is released form the lamp shade, especially when subjected to heat emanating from a light source. Typically, desirable fragrances will be released at a desirable level from the lamp shade when the temperature reaches typically at least 75° F.

What is claimed is:

1. A lamp comprising:
a) a base;
b) a light emitting fixture operatively connected to the base; and
c) a lamp shade secured over the light emitting fixture and comprised of a fragrance emitting material.

2. The lamp of claim 1 further comprising a source of light.

3. the lamp of claim 2 wherein the source of light emits sufficient heat to enhance release of the fragrance from the fragrance emitting material.

4. The lamp of claim 1 wherein the lamp shade is made of a fragrance emitting material.

5. The lamp of claim 1 wherein the fragrance emitting material comprises a material having a fragrance thereon.

6. The lamp of claim 1 wherein the lamp shade is made from a material selected from the group consisting of polyethylene, polypropylene, ethyl vinyl acetate, K-resin, styrene polymers and copolymers, rubbers, polyvinyl chloride, ethyl methacrylate polymers ABS, polyamide, acrylics, acrylic emulsions, latex and combinations thereof.

7. The lamp of claim 1 wherein the lamp shade comprises an injection molded plastic.

8. The lamp of claim 7 wherein the injection molded plastic contains the fragrance emitting material.

9. The lamp of claim 1 wherein the fragrance of the fragrance emitting material is released at a temperature of at least 75° F.

10. A lamp shade for securing about a light fixture of a lamp comprising a fragrance emitting material.

11. The lamp of claim 10 wherein the fragrance emitting material comprises a material having a fragrance thereon.

12. The lamp of claim 10 wherein the lamp shade is made from a material selected from the group consisting of polyethylene, polypropylene, ethyl vinyl acetate, K-resin, styrene polymers and copolymers, rubbers, polyvinyl chloride, ethyl methacrylate polymers ABS, polyamide, acrylics, acrylic emulsions, latex and combinations thereof.

13. The lamp of claim 10 wherein the lamp shade comprises an injection molded plastic.

14. The lamp of claim 13 wherein the injection molded plastic contains the fragrance emitting material.

15. The lamp of claim 10 wherein the fragrance of the fragrance emitting material is released at a temperature of at least 75° F.
